(19) United States
(12) Patent Application Publication
(10) Pub. No.: US 2014/0157313 A1
(43) Pub. Date: Jun. 5, 2014

(54) SYSTEM AND METHOD FOR CACHING AN ELECTRONIC PROGRAM GUIDE

(71) Applicants: Lee Douglas Shartzer, Valencia, CA (US); Samir Ahmed, Glendale, CA (US); John Bishop, Burbank, CA (US)

(72) Inventors: Lee Douglas Shartzer, Valencia, CA (US); Samir Ahmed, Glendale, CA (US); John Bishop, Burbank, CA (US)

(73) Assignee: Thomson Licensing, Issy de Moulineaux (FR)

(21) Appl. No.: 14/130,992

(22) PCT Filed: Jun. 28, 2012
(86) PCT No.: PCT/US12/44565

§ 371 Date: Jan. 6, 2014

Related U.S. Application Data
(60) Provisional application No. 61/521,971, filed on Aug. 10, 2011.

(51) Int. Cl. H04N 21/231; H04N 21/482

(52) U.S. Cl. CPC H04N 21/23106; H04N 21/482
USPC 725/39

(57) ABSTRACT

A method for caching an electronic program guide on a portable device commences by downloading channel information and program information to the portable from a local cache when the local cache contains relevant information. However, if the local cache lacks such information, the portable device downloads the channel information and program information from a server. The portable devices then builds a channel index and a program index from the downloaded channel information and program information, respectively to establish the electronic program guide on the portable device.

### CROSS-REFERENCE TO RELATED APPLICATIONS

This application claims priority under 35 U.S.C. 119(e) to U.S. Provisional Patent Application Ser. No. 61/521,971, filed Aug. 10, 2011, the teachings of which are incorporated herein.

### TECHNICAL FIELD

This invention relates to Electronic Program Guides (EPGs).

### BACKGROUND ART

Advances in technology have afforded television viewers and radio listeners with a plethora of programming. To that end, providers of television and radio content typically provide their consumers with electronic program guides (EPGs) and interactive program guides with continuously updated menus displaying scheduling information for current and upcoming programming. Some EPGs, such as ITV also feature backward scrolling to enable user to catch up on content.

In most instances, the set-top box serves (STB) as the mechanism via which a viewer will tune (i.e., select) content provided by a cable television or satellite television provider or other network service operator. To identify available content to the viewer, the STB will retrieve an EPG from a back end server maintained by the network service operator. Alternatively, the STB can obtain the EPG by decoding coded information in a Transport Stream (TS) received from the network service operator. The STB will archive the EPG onto a hard disk or the like during a process known as EPG installation, which can prove lengthy. In practice, the network service operator will frequently update the EPG based on changes in programming and channel assignments. Thus, the STB needs to update the EPG in the background to provide users with the most-current EPG.

Tablet computers, such as the Apple iPad®, as well as other portable devices such as smart phones, can interact with a home gateway or STB within a home network to provide a second screen for displaying information, typically in the form of metadata associated with content undergoing display on a primary display device such as a television set. The interaction of such tablet computers and smart phones with the STB can include functions such as channel zapping, volume adjustment, content tuning, relevant and complementary information navigation, and viewing. To avoid redundant network request from tablet computer or smart phone to the back-end server, caching of the EPG becomes necessary. Such caching allows local retrieval of the EPG, which enables smooth browsing of channels, programs, and schedule information.

Existing EPG caching methods focus on how to archive EPG in the manner of XML file format into hard disk, and how to read and write the files according to the file names, and then parse the XML file to get specific information. The shortcomings of this kind of solution include the following:

1. XML files consume a large volume of redundant storage space to store the element names, attributes names, tags, etc.;
2. Saving all channels, programs, and schedule information in a single XML file can prove very difficult. Storing such information into separate XML files requires redundant file I/O and redundant time to load all XML files in a specific directory.

Using a JavaScript Object Notation (JSON) message format instead of the XML format will yield a limited savings in time and storage capacity. However, the JSON message format is text based and still needs some tags to indicate the key and value pair. Serializing the EPG data into binary format on local disk can yield some improvement but still requires in organizing separate different programs into different files, so the indexing and navigation remain time consuming and inefficient.

Thus, a need exists for a technique for caching an EPG on a portable device, which overcomes the aforementioned difficulties.

### BRIEF SUMMARY OF THE INVENTION

Briefly, in accordance with a preferred embodiment of the present principles, a method for caching an electronic program guide on a portable device commences by downloading channel information and program information to the portable from a local cache when the local cache contains relevant information. However, if the local cache lacks such information, the portable device downloads the channel information and program information from a server. The portable devices then builds a channel index and a program index from the downloaded channel information and program information, respectively to establish the electronic program guide on the portable device.

### BRIEF DESCRIPTION OF THE DRAWINGS

FIG. 1 depicts a block diagram of a home network that includes at least one portable device for caching an electronic program guide from one of a local cache or a back end system in accordance with the present principles;

FIG. 2 depicts a time sequence of events associated with the portable device of FIG. 1 caching an electronic program guide in accordance with the present principles;

FIG. 3 depicts a table showing the sequence of programs for individual channels on individual days;

FIG. 4 depicts an enlarged view of FIG. 3 showing the build-up of program segments for a given channel on a given day; and

FIG. 5 depicts a table showing binary storage of the program information.

### DETAILED DESCRIPTION

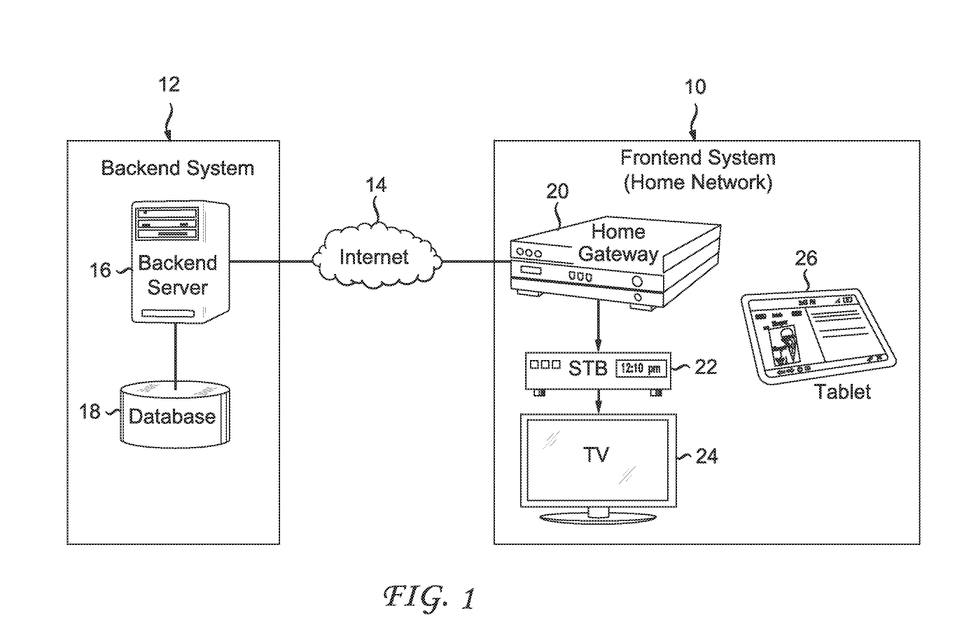

FIG. 1 depicts a block diagram of a home network 10 that receives both content and program guide information from a back end system 12 across a network 14. In the illustrated embodiment of FIG. 1, the network 14 constitutes the Internet. However, the network 14 can take other forms, such as a proprietary network maintained by a cable television, satellite television provider, or other network system operator. Further, the network 14 can take the form of a wide-area network, a local area network or a wireless network, or combination thereof with public or private access.

The back end system 12 typically includes at least one server 16 coupled to the network 14 for providing information from at least one database 18. The information can include content, in the form of audio-visual files represent movies or television programming for example. Further, the information can channel information and program information utilized by devices in the home network to create an electronic program guide. Although FIG. 1 depicts the back end system comprised of a single server 16 and a single database 18, in practice, the back end system can include multiple servers and/or multiple databases.

The home network 10 includes a home gateway 20, which provides a primary interface between the network 14 and other devices in the home network, such as for example a set-top box (STB) 22 for selecting content (e.g., television programming) for display on a television set 24. Although FIG. 1 depicts a single STB 22, the home gateway 20 has the capability of serving multiple STBs as well as other devices, such as a personal computer; provided that the back end system 12 or another system (not shown) provides Internet connectivity to the home network 10.

The home network 10 can include one or more portable devices, illustratively depicted by portable device 26 which can take the form of a table computer such as an Apple iPad® for example having one or more processors (not shown). In practice, the portable device 26 communicates with the home gateway 20 over a wireless link, such as a Wi-Fi link provided by the gateway or a wireless router (not shown) connected thereto. The ability of the portable device 26 to communicate with the gateway 20 allows the tablet computer to interact with the STB 22. In this way, the portable device 26 can perform include functions such as channel zapping, volume adjustment, content tuning, relevant and complementary information navigation, and viewing.

In order for a user to utilize the portable device 26 to perform functions such as channel tuning for example, the portable device should possess the ability to display an electronic program guide similar to the electronic program guide typically provided by the STB 22. In order to display an EPG, the STB 22 can retrieve an EPG from the back end system through the home gateway 20. Alternatively, the STB can obtain the by decoding coded information in a Transport Stream (TS) contain contents received from back end system 12 through the home gateway 20. The STB 22 will archive the EPG onto a hard disk or the like (not shown). In practice, the network service operator will frequently update the EPG based on changes in programming and channel assignments.

Current techniques for caching an EPG on a portable device generally require the portable device directly download the necessary information directly from the back end system 12 each time the portable device needs to update itself. The more portable devices that exist within the home network 10, the greater the demand on the back end system, thereby increasing traffic on the network 14.

In accordance with the present principles, caching of an EPG on the portable device, 26 advantageously occurs by having the portable device execute set of program instructions, as described hereinafter. The set of program instructions, when executed by the portable device 26 cause the device to first query the set-top box 22 of FIG. for “relevant” EPG information first and if such information exists at the STB, then the portable device will download the data therefrom. However, if the STB 22 lacks such information, then the portable device 26 will download the information from the back end system 12. The term “relevant” refers to EPG information (typically channel and program information) recently updated within a certain interval. In practice, the back end system 12 of FIG. 1 will update the STB 22 at regular intervals, for example every ten minutes. Assuming an update frequency of every ten minutes, EPG information at the STB 22 older than 10 minutes does not possess relevance when the portable device 26 queries the STB for relevant EPG information.

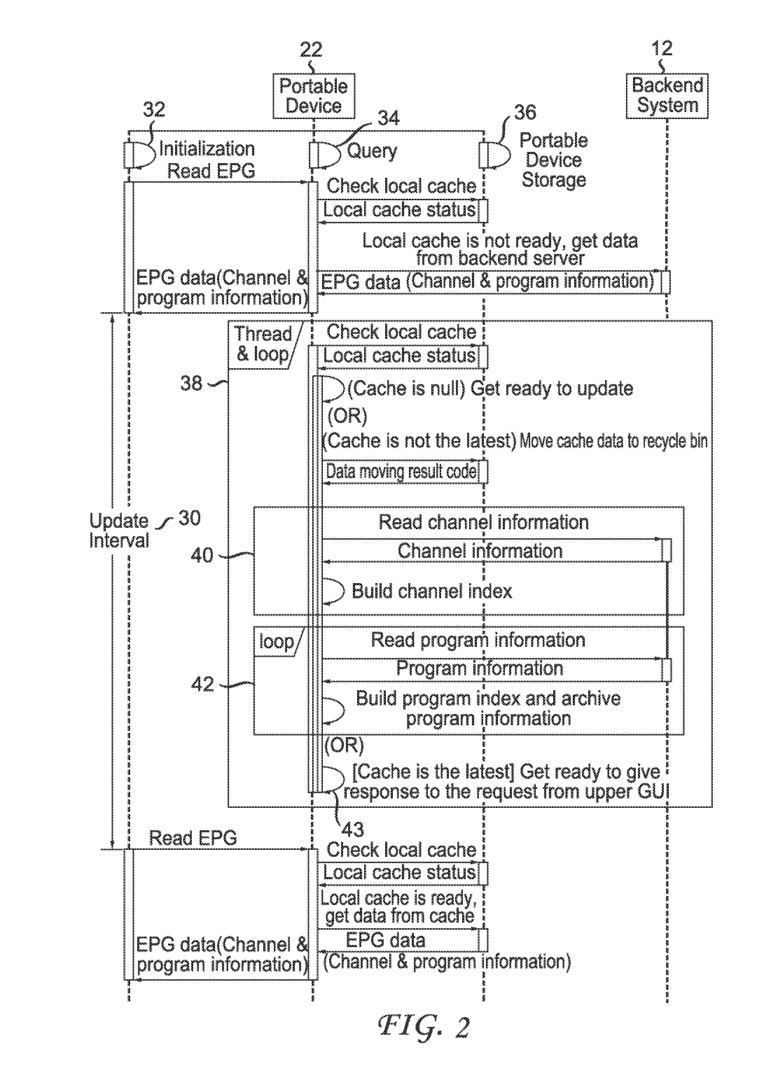

FIG. 2 depicts the sequence of events associated with the portable device 26 of FIG. 1 caching an electronic program guide in accordance with the present principles. At regular intervals, exemplified by the update interval 30 in FIG. 2, the portable device 26 of FIG. will cache an EPG in by first executing an initialization step 32 to prepare for the step 34 during which, the portable device 26 first queries a local cache within the home network 10 of FIG. 1 storing relevant EPG information. In practice, the local cache of EPG information resides in the STB 22 of FIG. 1. However, in some instances, the local cache could reside in another device in the home network, such as the home gateway 20 assuming that such a device archives EPG information.

In response to the query from the portable device 26, the local cache (e.g., the STB 22) will respond with its status, i.e., whether the local cache current contains relevant EPG information. Assuming the local cache has relevant EPG information; the portable device 26 will download such information from the local cache and store such relevant EPG information typically on a hard drive or other storage mechanism within the portable device. If the local cache does not possess relevant EPG information, e.g., the cached EPG information is no longer current, then the portable device 26 will download the EPG information from the backend server 12 of FIG. 1 for storage in the portable device.

The block 38 in FIG. 2 depicts a more detailed illustration of the steps associated with caching the EPG information by the portable device 26. As discussed previously, the caching process includes the steps of querying the local cache, which in turn will respond with its status. If the local cache has relevant EPG information, then the portable device 26 will download such information from the local cache for storage on the portable device. Otherwise, the portable device 26 will download that information from the back end system 12 for storage on the portable device.

In practice, the EPG information can exceed 100 mega bytes in size so caching (i.e., downloading) the EPG information in a single request becomes impractical. For that reason, the portable device 26 executes the steps in block 38 to successively read the EPG information. In practice, the portable device 26 will execute a first loop 40 to successively read channel information, from either the local cache or the back end system 12 as previously described, and then download the channel information for storage on the portable device. After downloading and storing the channel information, the portable device 26 will build a channel index. The portable device 26 will execute a second loop 42 to successively read program information and then download the program information for storage on the portable device. After downloading and storing the channel information, the portable device 26 will build a program index. From the channel index and the program index, the portable device 26 will create an EPG during step 43 for display in response to a request for an EPG graphical user interface from a user.

Each channel includes at least one, and preferable, a plurality of programs, each having its own schedule. The start and stop time constitute important properties for each program schedule. The following comprises exemplary C-language program code for calculating the time blocks of program schedules:

```
void cacheBuildBlocks(ChannelIndex chlIdx, EpgProgram[ ] programs)
{
    try
    {
        for (int i = 0; i < programs.Length; i++)
        {
            chlIdx.ids[i] = programs[i].id;
            Schedule schedule = programs[i].schedule;
            long schStart = schedule.startTime;
            long schEnd = schedule.endTime;
            DateTime startDate =
            DateTimeUtil.getDate(m_epgCacheDate.start);
            DateTime schStartDate = DateTimeUtil.getDate(schStart);
            DateTime schEndDate = DateTimeUtil.getDate(schEnd);
            int startBlock = getBlock(schStart);
            DateTime bDate = chlIdx.blockDates[startBlock];
            DateTime programBlockDate = blockDate(startBlock);
            if (startBlock < 0)
            {
                throw new Exceptione(“Invalid range of
                EPG date & time.”);
            }
            if (Math.Abs(DateTimeUtil.getTime(bDate) − schStart) >
            (min_unit * interval))
            {
                throw new Exception(“Invalid range of EPG date &
                time.”);
            }
            int endBlock = getBlock(schedule.endTime);
            for (int k = startBlock; k <= endBlock; k++)
            {
                chlIdx.blocks[k] = i;
            }
        }
    }
    catch (Exception e)
    {
        logger.Error(e.Message);
    }
}
int getBlock(long schStart)
{
    long lngOffset = schStart − m_epgCacheDate.start;
    Double potentialBlock = (Double)(lngOffset / min_unit / interval);
    return (int)Math.Ceiling(potentialBlock);
}
DateTime blockDate(int block)
{
    long blockTime = m_epgCacheDate.start +(long)(block *
    min_unit * interval);
    return DataTimeUtil.getDate(blockTime);
}
```

An exemplary set of programming instructions in the C-programming language for retrieving EPG data appears below. When executed by a processor (not shown) within the portable device 26 of FIG. 1, the programming instructions listed below calculate the time blocks according to the input parameters of “startDateTime” and “duration.” The variable “startDateTime” indicates the specific start date and time of programs within the EPG for a single query. Calculation of the offset and length of the program information archived onto local disk or other storage mechanism within the portable device makes use of the time block variables including “startBlock” and “endBlock.” The offset and length facilitate reading of the program information from a storage device.

```
EpgChannel[ ] cacheRetrieve(int startChannelIndex, int count, long startDateTime, int
duration, bool includePrograms)
{
    EpgChannel[ ] resultChannels = null;
    try
    {
        // Copy channelMap array starting with startChannelIndex for count items.
        resultChannels = new EpgChannel[count];
        // Copy channels array from channelMap to resultChannels.
        Array.Copy(channelMap, startChannelIndex, resultChannels, 0, count);
        if (includePrograms)
        {
            // Calculate start & end block
            int startBlock = getBlock(startDateTime);
            int endBlock = getBlock(startDateTime + duration);
            DataTime blockDate = channelIndex[0].blockDates[startBlock];
            for (int i = startChannelIndex; i < (startChannelIndex + count) && i <
channelIndex.Length; i++)
            {
                int programStart = startBlock;
                int programEnd = endBlock;
                if (programStart < channelIndex[i].blocks.Length && programEnd > 0)
                {
                    if (programStart < 0)
                    {
                        programStart = startBlock = 0;
                    }
                    int findStart = programStart;
                    if (findStart < channelIndex[i].blocks.Length && findStart <
endBlock)
                    {
                        int pOff = channelIndex[i].blocks[findStart];
                        int lastBlock = endBlock;
                        while (pOff == −1 && (findStart − 1) >0)
                        {
                            findStart−−;
                            pOff = channelIndex[i].blocks[findStart];
                        }
                        if (pOff != −1)
                        {
                            int findEnd = channelIndex[i].blocks[programEnd];
                            while (findEnd == −1 && ((programEnd + 1) <
channelIndex[i].blocks.Length))
                            {
                                programEnd++;
                                findEnd = channelIndex[i].blocks[programEnd];
                            }
                            if (findEnd == −1)
                            {
                                programEnd = findStart;
                            }
                            int pLen = (channelIndex[i].blocks[programEnd] −
channelIndex[i].blocks[findStart]) + 1;
                            // Copy programs array in channel array from file
“channelPrograms”
                            // pointed by channelIndex to resultChannels.
                            EpgProgram[ ] pTmp = new EpgProgram[pLen];
                            for (int j = channelIndex[i].blocks[findStart]; j <=
channelIndex[i].blocks[programEnd] && j < channelIndex[i].programs.Length; j++)
                            {
                                long stt = channelIndex[i].programs[j].off;
                                int len = channelIndex[i].programs[j].len;
                                pTmp[j − pOff] =
(EpgProgram)m_file_programs.readObject(stt, len);
                            }
                            if (pLen > 0)
                            {
                                DateTime firstProgram =
DateTimeUtil.getDate(pTmp[0].schedule.startTime);
                            }
                            resultChannels[i − startChannelIndex].programs = new
EpgProgram[pLen];
                            Array.Copy(pTmp, 0, resultChannels[i −
startChannelIndex].programs, 0, pLen);
                        }
                    }
                }
            }
        }
    }
    catch (Exception e)
    {
        logger.Error(e.Message);
    }
    return resultChannels;
}
int getBlock(long schStart)
{
    long lngOffset = schStart − m_epgCacheDate.start;
    Double potentialBlock = (Double)(lngOffset / min_unit / interval);
    return (int)Math.Ceiling(potentialBlock);
```

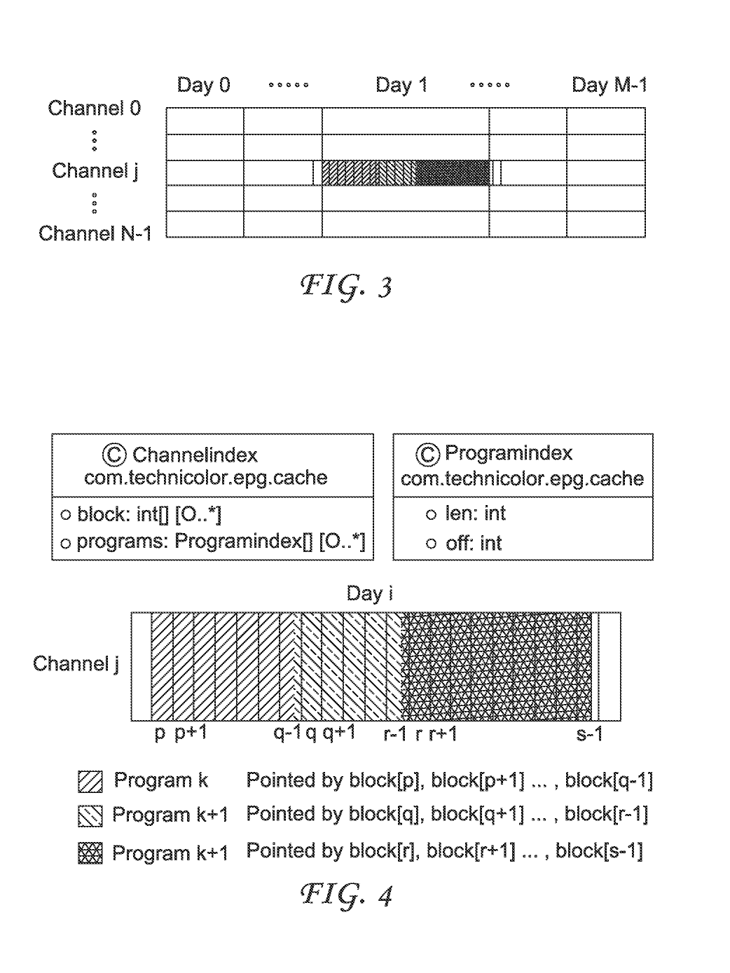

FIG. 3 depicts a table showing the sequence of programs for individual channels on individual days, providing an overview of the caching method in accordance with present principles. For ease of illustration, FIG. 3 depicts a day range from 0 to M−1 and a channel range is from 0 to N−1. The EPG program information has an arrangement according to the sequence of the time schedules. As an example, the program block within the EPG for Day(i) and Channel(j) includes 3 programs, each marked with a different shading.

FIG. 4 depicts an enlarged view of FIG. 3 showing the build-up of program segments for each of the three programs, designated as Program (k), Program (k+1) and Program (k+2), respectively. Program(k) comprises a sequence of segments represented by block[p], block[p+1] . . . block[q−1]. Program(k+1) comprises a sequence of segments represented by block[q], block[q+1] . . . block[r−1]. Lastly, Program(k+2) comprises a sequence of segments represented by block[r], block[r+1] . . . block[s−1]. Each block depends on the program schedule.

The data structures “ChannelIndex” and “ProgramIndex” play important roles in the EPG guide portion shown in FIG. 4. Within the “ChannelIndex” data structure, the element bearing the notation “channel Number” corresponds to the channel number and serves as a unique identification of a specific channel. The program segments constitute an integer array, which enables reference to a point in a specific program in an associated channel. As discussed previously, the program segments depend on the program schedule, including the start time and end time of the program. The data structure “ProgramIndex” constitutes an array of values, each bearing the notation “ProgramIndex.” For the data structure “ProgramIndex,” the variables “off” and “len” serve to identify the recorded the offset and length of the program information, respectively, archived onto local disk of the portable device 26 of FIG. 1. From these two data structures, the EPG start and end time enable calculation of the blocks, which enable calculation of the pointed programs. The pointed programs can be read from local disk according to their offset and length.

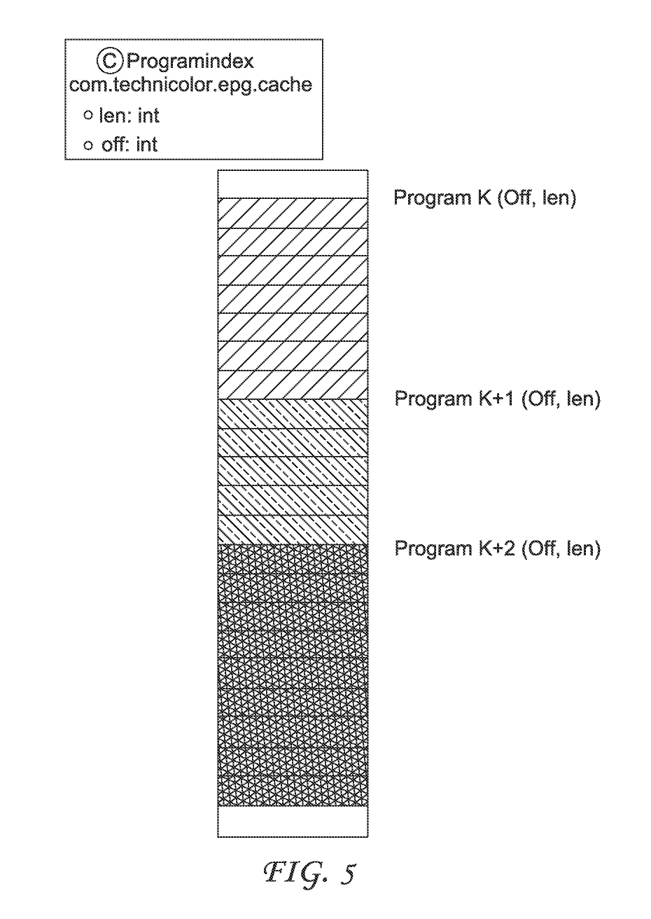

FIG. 5 depicts a table showing binary storage of the program information, showing each of the individual segments of each program stored in a separate memory block. As discussed previously, the variables “off” and “len” associated with the “ProgrammingIndex” data structure identify the recorded the offset and length, respectively, of the program information. The offset and “length” constitute integer values and represent the binary byte offset and length for the archived program information.

The foregoing describes a technique for archiving Electronic Program Guide (EPG) information on a portable device.

1. A method for caching an electronic program guide on a portable device, comprising the steps of:
downloading channel information and program information to the portable device from a local cache when the local cache contains relevant information; otherwise
downloading the channel information and program information to the portable device from a server; and
building a channel index and a program index from the downloaded channel information and program information, respectively to establish the electronic program guide on the portable device.

2. The method according to claim 1 wherein the step of downloading channel information and program information to the portable from a local cache comprises the step of downloading the channel information and program information from a set-top box in a home network.

3. The method according to claim 1 wherein the step of downloading channel information and program information to the portable from a local cache comprises the step of downloading the channel information and program information from a gateway in a home network.

4. The method according to claim 1 wherein the downloaded channel information comprises a sequence of blocks, each identified by a specific channel number.

5. The method according to claim 4 wherein the downloaded program information includes starting time and program length information of programs in each block of the channel information.

6. The method according to claim 1 wherein relevant information comprises EPG information that had been recently updated.

7. A portable device for caching an Electronic program Guide, comprising:
means for downloading channel information and program information to the portable from a local cache when the local cache contains relevant information; otherwise
means for downloading the channel information and program information to the portable device from a server; and
means for building a channel index and a program index from the downloaded channel information and program information, respectively to establish the electronic program guide on the portable device.

8. The portable device according to claim 7 wherein the downloaded channel information comprises a sequence of blocks, each identified by a specific channel number.

9. The portable device according to claim 8 wherein the downloaded program information includes starting time and program length information of programs in each block of the channel information.

10. The portable device according to claim 7 wherein relevant information comprises EPG information that had been recently updated.
